(19) United States
(12) Patent Application Publication
(10) Pub. No.: US 2013/0311790 A1
(43) Pub. Date: Nov. 21, 2013

(54) Secure Three-Dimensional Mask-Programmed Read-Only Memory

(71) Applicants: Guobiao ZHANG, Corvallis, OR (US); ChengDu HaiCun IP Technology LLC, ChengDu (CN)

(72) Inventor: Guobiao ZHANG, Corvallis, OR (US)

(73) Assignees: ChengDu HaiCun IP Technology LLC, ChengDu (CN); Guobiao ZHANG, Corvallis, OR (US)

(21) Appl. No.: 13/951,462

(22) Filed: Jul. 26, 2013

Related U.S. Application Data
(63) Continuation of application No. 13/027,274, filed on Feb. 15, 2011.

(51) Int. Cl. G06F 12/14

(52) U.S. Cl. CPC G06F 12/1408
USPC 713/193

(57) ABSTRACT

A secure three-dimensional mask-programmed read-only memory (3Dm-ROM_{S}) comprises a 3Dm-ROM for storing mass information, a non-mask-programmed memory (NMP) for storing at least a key and an encryption logic for encrypting selected data from said mass information with said key. Because different 3Dm-ROM_{S} devices from a same 3Dm-ROM_{S} batch are encrypted with different keys, compromising one device would not compromise others.

### CROSS-REFERENCE TO RELATED APPLICATIONS

This is a continuation of application entitled “Secure Three-Dimensional Mask-Programmed Read-Only Memory”, Ser. No. 13/027,274, filed Feb. 15, 2011.

### BACKGROUND

1. Technical Field of the Invention

The present invention relates to the field of integrated circuit, and more particularly to mask-programmed read-only memory (mask-ROM).

2. Prior Arts

Mass information dissemination refers to mass distribution of mass information.

“Mass information” contains gigabytes (GB) of data, even terabytes (TB) of data. Examples of mass information include visual contents (e.g. photos, digital maps, movies, television programs, videos, video games), audio contents (e.g. music, songs, audio books), textual contents (e.g. electronic books, or ebooks), softwares and their libraries (e.g. movie/video library, video-game library, digital map library, music library, ebook library, software library). The data for visual, audio, textual and/or other contents is referred to as content data. “Mass distribution” means distributing hundreds of thousands of copies, even millions of copies, to users. Before distribution, mass information is recorded and stored in mass storage. Mass storage prefers small physical size, low recording cost, low storage cost and strong copyright protection.

Three-dimensional read-only memory (3D-ROM) is considered an ideal storage for mass information dissemination. U.S. Pat. No. 5,835,396 issued to Zhang on Nov. 10, 1998 discloses a 3D-ROM. It is a monolithic semiconductor memory. As illustrated in FIG. 1, a typical 3D-ROM comprises a semiconductor substrate 00 and a 3D-ROM stack 10. The semiconductor substrate 00 comprises transistors and their interconnects, which form the peripheral circuit and other functions. The 3D-ROM stack 10 comprises a plurality of memory levels (e.g. 100, 200), which are monolithically stacked above one another and further above the substrate 00. Each memory level (e.g. 100) comprises a plurality of address lines (e.g. 1a . . . ; 2a . . . ) and memory cells (e.g. 5aa). Memory cells (e.g. 5aa) are formed at the intersection between two address-selection lines (e.g. 1a and 2a). Contact vias (e.g. 1av, 3av) couple memory levels (e.g. 100, 200) to the substrate 00. Based on how data is recorded, 3D-ROM can be categorized into two classes: electrically-programmable 3D-ROM (3D-EPROM) and mask-programmed 3D-ROM (3Dm-ROM, also known as 3D-MPROM in prior patents/applications).

3D-EPROM refers to the 3D-ROM whose data is electrically written. Examples of 3D-EPROM include 3D-OTP (3-D one-time programmable memory) and 3D-RW (3-D read-write memory). FIG. 2 illustrates a typical 3D-EPROM cell 5e. It comprises a diode layer 7d and an antifuse layer 7a. The electrical resistance of the diode layer 7d is higher when current flows in one direction than in the opposite direction. The antifuse layer 7a is an insulating layer before programming. It can be ruptured and become conductive after programming. The antifuse integrity represents the digital state of the memory cell.

3Dm-ROM refers to the 3D-ROM whose data is defined by mask(s) during manufacturing. FIGS. 3A-3B illustrate two exemplary 3Dm-ROM cells 5m0, 5m1. The 3Dm-ROM cell 5m0 in FIG. 3A represents digital “0”, where a blocking dielectric 7b electrically isolates two address-section lines 1a and 2a. The 3Dm-ROM cell 5m1 in FIG. 3B represents digital “1”, where a contact 7c is formed in the blocking dielectric 7b to couple two address-section lines 1a and 2a. The contact patterns (i.e. existence or absence of contacts) in the blocking dielectric, defined by at least one data-mask, are patterns representing the content data stored in the 3Dm-ROM, or data patterns. In the present invention, the phrase “a ROM batch” refers to all read-only memory (ROM) devices whose content data is hard-coded by the same tool set (e.g. the same data-mask set, or the same master DVD). For example, in a 3Dm-ROM batch, the data patterns of all 3Dm-ROM devices are defined by the same data-mask set. Apparently, all ROM devices in a ROM batch store the same content data.

3D-EPROM was considered as the most promising 3D-ROM and has been the major focus of research and development in the last decade. However, as is inherent with any diode-based matrix-type memory, 3D-EPROM has a slow write speed. With a typical write speed of ˜1.5 MB/s (referring to “Sandisk 3D-OTP Memory Specifications”), it takes a long time to record mass information, e.g. ˜3 hours to record a high-definition movie (˜20 GB). This long recording time and the associated high recording cost make it questionable to use 3D-EPROM for mass information dissemination.

In fact, when recording data to a storage device for mass information dissemination, printing is more suitable than writing because it has a much faster data-transfer speed. As traditional publication (i.e. paper printing) and optical storage (i.e. disc printing), this is also true for semiconductor storage. By printing data optically (i.e. through photolithography) into 3Dm-ROM, the content data can be rapidly and economically reproduced on a large number of dice in a short time. For example, ˜20 GB of data (enough for a high-definition movie) can be printed onto hundreds of dice in a single photolithography step. Photolithography—this large-scale industrial printing process—makes 3Dm-ROM more suitable for mass information dissemination.

For 3Dm-ROM, and more generally, any hard-coded ROM (i.e. the ROM whose content data is hard-coded), the content data is stored in an encrypted form. This is a general approach employed by prior arts to protect the copyright of their contents. For example, DVD-ROM uses content scrambling system (CSS) to protect the copyright of its video contents. Although this approach improves copyright protection to a certain degree, a security flaw was not recognized in the past. Being hard-coded, the content data is encrypted in the same way (e.g. by a same encryption key or a same set of encryption keys) for all ROM devices in the same ROM batch. If one device in a ROM batch is compromised (e.g. its encryption key is broken), then all devices in the same batch will be compromised. This is a lesson learned from DVD-ROM, where DeCSS essentially broke copyright protection for all DVD-ROM's. This security flaw is faced by every kind of hard-coded ROM (including 3Dm-ROM). No technical solution has yet been identified.

### OBJECTS AND ADVANTAGES

It is a principle object of the present invention to further improve copyright protection for 3Dm-ROM.

It is a further object of the present invention to avoid compromising all 3Dm-ROM devices in a 3Dm-ROM batch if one 3Dm-ROM device in the same batch is compromised.

In accordance with these and other objects of the present invention, a secure three-dimensional mask-programmed read-only memory (3Dm-ROM_{S}) is disclosed.

### SUMMARY OF THE INVENTION

The present invention discloses a secure 3Dm-ROM (3Dm-ROM_{S}). It comprises a 3Dm-ROM, a non-mask-programmed memory (NMP) and an encryption logic. The 3Dm-ROM comprises a plurality of monolithically stacked mask-ROM levels which store the content data for mass information. Being hard-coded, the content data is same for all 3Dm-ROM_{S} devices in a 3Dm-ROM_{S} batch. The NMP stores encryption key(s) and can be written by non-mask-programming (e.g. optical, electrical, or magnetic programming) means. Being soft-coded, key(s) may be different for different 3Dm-ROM_{S} devices in a same 3Dm-ROM_{S} batch. The encryption logic encrypts selected content data with a key selected from the NMP. For different 3Dm-ROM_{S} devices in a same 3Dm-ROM_{S} batch, a same content data may be encrypted with different keys. Hence, even if one device in a 3Dm-ROM_{S} batch is compromised (e.g. its encryption key is broken), other devices in the same 3Dm-ROM_{S} batch would not be compromised.

To further improve copyright protection, 3Dm-ROM_{S} is preferably formed in a single chip. This can prevent the intermediate signals between the 3Dm-ROM and the encryption logic from being exposed to the external worlds. As a result, the content data stored in the 3Dm-ROM is difficult to be tampered with. Apparently, this concept of integrating the information storage (e.g. 3Dm-ROM), the key storage (e.g. NMP) and the encryption logic into a single chip can be extended to any mask-ROM. Moreover, as is inherent with 3Dm-ROM_{S}, at least a portion of its NMP can be formed underneath the 3Dm-ROM arrays. This is advantageous because uncovering the underlying NMP requires removal of the 3Dm-ROM array, which defies the whole purpose of pirating.

### BRIEF DESCRIPTION OF THE DRAWINGS

FIG. 1 is a cross-sectional view of a three-dimensional read-only memory (3D-ROM);

FIG. 2 is a cross-sectional view of an electrically-programmable 3D-ROM (3D-EPROM) cell;

FIGS. 3A-3B are cross-sectional views of mask-programmed 3D-ROM (3Dm-ROM) cells at states “0” and “1”, respectively;

FIG. 4 is a block diagram of a preferred secure three-dimensional mask-programmed read-only memory (3Dm-ROM_{S});

FIG. 5 is a block diagram of another preferred 3Dm-ROM_{S};

FIG. 6 is a cross-sectional view of a preferred 3Dm-ROM_{S} chip;

FIG. 7 is a top view of the preferred 3Dm-ROM_{S} chip, showing 3Dm-ROM array and its peripheral circuit;

FIGS. 8A-8C illustrate three cases of the 3Dm-ROM_{S} chips of FIG. 7 with the 3Dm-ROM array not shown, revealing the substrate;

FIG. 9 is a cross-sectional view of a preferred 3Dm-ROM_{S} package;

FIGS. 10AA-10BB illustrate two cases of the 3Dm-ROM_{S} package of FIG. 9.

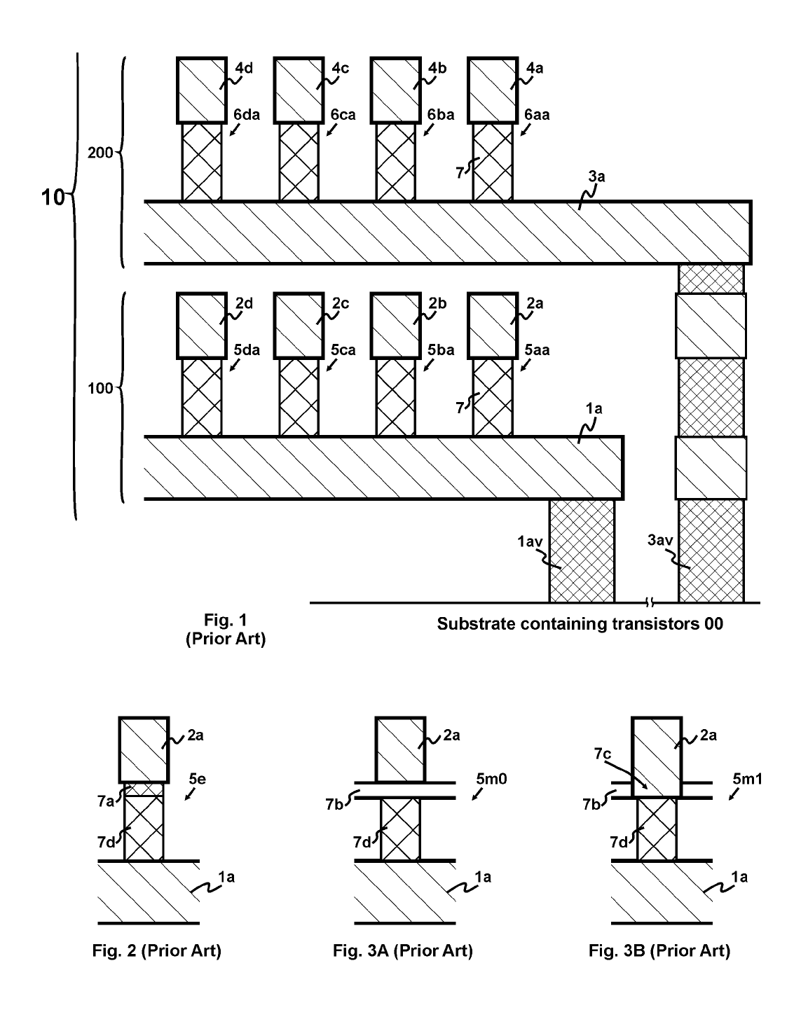

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

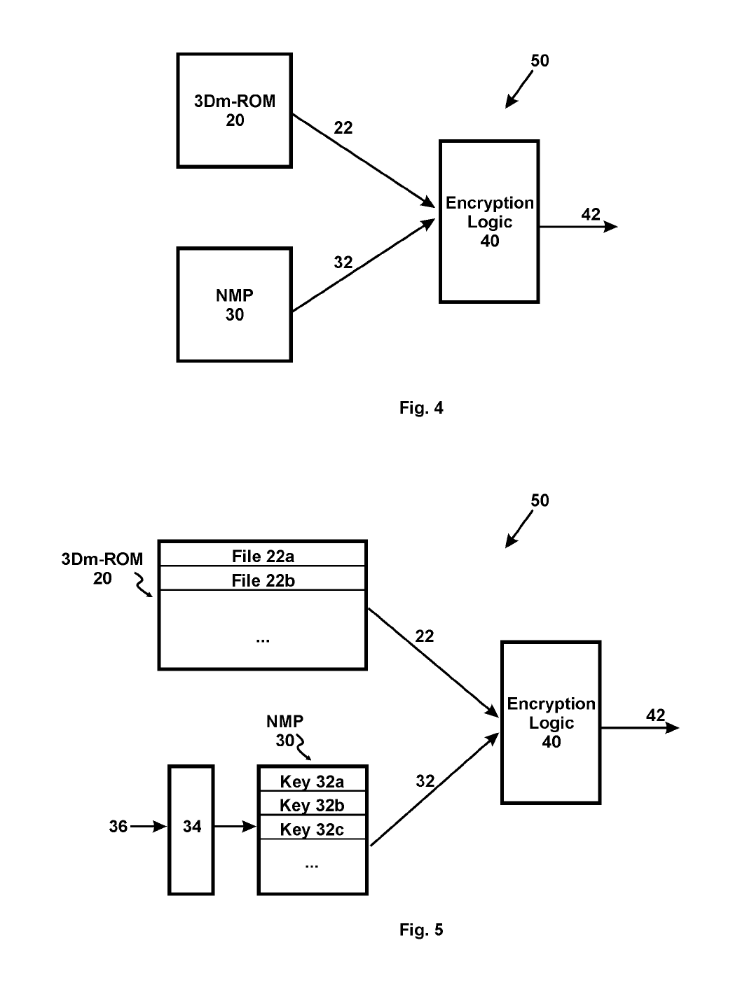

Referring to FIG. 4, a preferred secure three-dimensional mask-programmed read-only memory (3Dm-ROM_{S}) 50 is disclosed. It comprises a 3Dm-ROM 20, a non-mask-programmed memory (NMP) 30 and an encryption logic 40. The 3Dm-ROM 20 comprises a plurality of monolithically stacked mask-ROM levels which store the content data 22 for mass information. Note that the content data for mass information is printed into the mask-ROM levels by a mask-programming means. Being hard-coded, the content data is same for all 3Dm-ROM_{S} devices in a 3Dm-ROM_{S} batch. The content data could be either in a plaintext or encrypted form. When encrypted, the content data for all 3Dm-ROM_{S} devices in a same 3Dm-ROM_{S} batch is encrypted by a same encryption key or a same set of encryption keys.

The NMP 30 stores encryption key(s) 32. It is a non-volatile memory that can be written by non-mask-programming (e.g. optical, electrical, or magnetic programming) means. Key(s) can be written into the NMP 30 during/after manufacturing. Examples of NMP include laser-programmable read-only memory (LP-ROM) and electrically writable read-only memory. Here, electrically-writable read-only memory includes programmable read-only memory (PROM, e.g. antifuse-based or fuse-based), electrically programmable read-only memory (EPROM, including 3D-EPROM), and electrically erasable programmable read-only memory (E²PROM, including flash memory). Being soft-coded, key(s) 32 may be different for different 3Dm-ROM_{S} devices in a same 3Dm-ROM_{S} batch.

The encryption logic 40 encrypts selected content data 22 with a key 32 selected from the NMP 30. Different encryption algorithms may be employed, e.g. PGP, AES, 3DES, Blowfish, or others. The encryption logic 40 could also be a data scrambler, which re-arranges content data 22 according to a pattern defined by the key 32. To improve the efficiency of the encryption logic 40, the content data may be partially encrypted.

For different 3Dm-ROM_{S} devices in a same 3Dm-ROM_{S} batch, their content data may be encrypted with different keys. Hence, even if one device in a 3Dm-ROM_{S} batch is compromised (e.g. its encryption key is broken), other devices in the same 3Dm-ROM_{S} batch would not be compromised. For example, for a 3Dm-ROM_{S} batch comprising at least a first device A and a second device B, they both store the same contents, but the keys (which are stored in their NMP's) used to encrypt their contents are different. As a result, even if the first device A is comprised (e.g. its key is broken), the second device B would not be compromised because it uses a different key.

Referring now to FIG. 5, another preferred 3Dm-ROM_{S} 50 is disclosed. It further enhances copyright protection by providing file-dependent encryption and/or time-variant encryption. The preferred embodiment in FIG. 5 comprises a 3Dm-ROM 20, an NMP 30, a key-selection logic 34 and an encryption logic 40. The 3Dm-ROM 20 stores at least one data file 22a . . . , and the NMP 30 stores a plurality of keys 32a, 32b . . . . The key-selection logic 34 selects key(s) based on input 36 such as file address, time or other information.

When the key is selected based on file address, different data files are encrypted by different keys. For example, data file 22a is encrypted by key 32a, while data file 22b is encrypted by key 32b . . . . On the other hand, when the key is selected based on time, data files are encrypted by different keys during different time periods. For example, data file 22a is encrypted by key 32a during the time period T₁, and encrypted by key 32c during the time period T₂ . . . . All these features add complexity to breaking into 3Dm-ROM_{S}. Apparently, other copyright-enhancing techniques can also be used. For example, different portions of the data file can be encrypted by different keys.

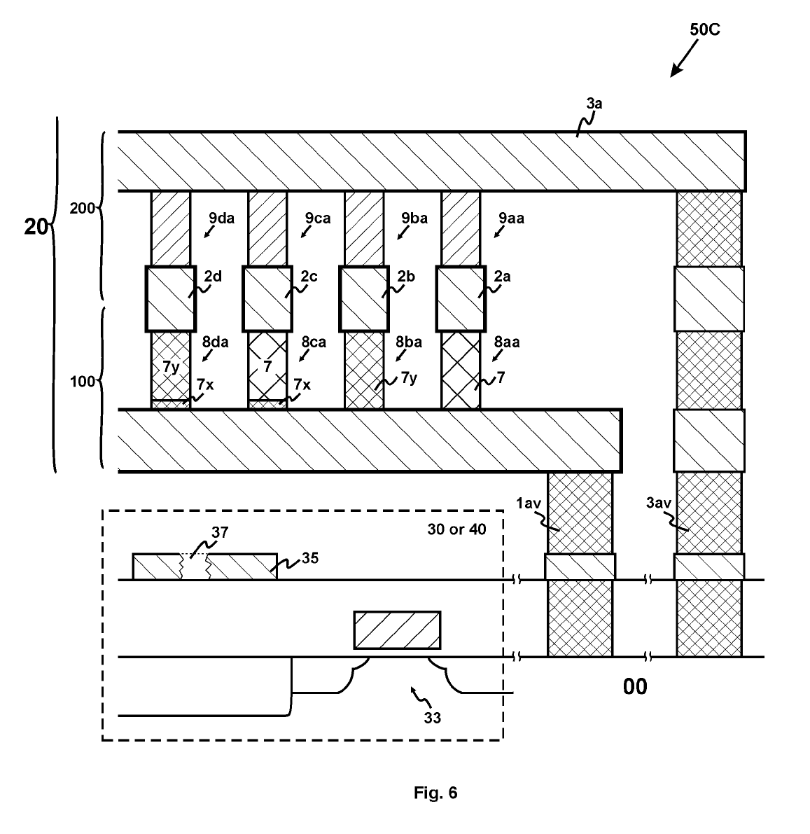

FIG. 6 illustrates a cross-sectional view of a preferred 3Dm-ROM_{S} chip 50C. In this preferred embodiment, the 3Dm-ROM 20, the NMP 30 and the encryption logic 40 are integrated into a single chip. Because all data connections are located inside the chip 50C, the intermediate signals between the 3Dm-ROM 20 and the encryption logic 40 are not exposed to the external world and would be difficult to be tampered with. Accordingly, this preferred embodiment provides excellent copyright protection. Apparently, this concept of integrating the information storage (e.g. 3Dm-ROM), the key storage (e.g. NMP) and the encryption logic into a single chip can be extended to any mask-ROM.

The 3Dm-ROM array 20 is formed above and coupled to the substrate 00 via contact vias 1av, 3ay . . . . It comprises a plurality of mask-ROM levels (e.g. 100, 200 . . . ). The 3Dm-ROM can improve its storage density by using multi-bit-per-cell (referring to U.S. patent application Ser. No. 12/785,621, “Large bit-per-cell Three-Dimensional Mask-Programmable Read-Only Memory”, filed on May 24, 2010), i.e. each memory cell (e.g. 8aa-8da . . . ) stores multiple bits. The 3Dm-ROM can further improve its storage density by using a hybrid-level structure (referring to U.S. patent application Ser. No. 12/476,263, “Hybrid-Level Three-Dimensional Mask-Programmable Read-Only Memory”, filed on Jun. 2, 2009), i.e. some address-selection lines (e.g. 2a-2d . . . ) are shared by adjacent memory levels (e.g. 100, 200). At the F=20 nm node, a 3Dm-ROM with eight memory levels and two bits per cell can reach a storage density of ˜1 Tb/cm².

In the preferred 3Dm-ROM_{S} chip 50C of FIG. 6, the NMP 30 and the encryption logic 40 are preferably formed below 3Dm-ROM array 20. Because their building blocks are transistors 33, at least a portion of the NMP 30 and/or the encryption logic 40 are formed in the substrate 00. Here, the phrase “in the substrate” should be interpreted as “in the substrate” or “on the substrate”. In this preferred embodiment, the NMP 30 is a laser-programmable read-only-memory (LP-ROM). It comprises a laser-programmable fuse 35 and can be programmed during manufacturing, e.g. before the 3Dm-ROM arrays are formed. By shining a laser beam onto the fuse 35, a gap 37 can be formed in the fuse 35. Existence or absence of the gap 37 indicates the digital state of the LP-ROM cell. Among all types of NMP, LP-ROM is particularly advantageous because it does not require high-voltage programming transistor and incurs minimum process change. Note that, although it is programmed by changing the physical structure of the fuse, LP-ROM is still considered as “soft-coded” because different data can be programmed into different LP-ROM's.

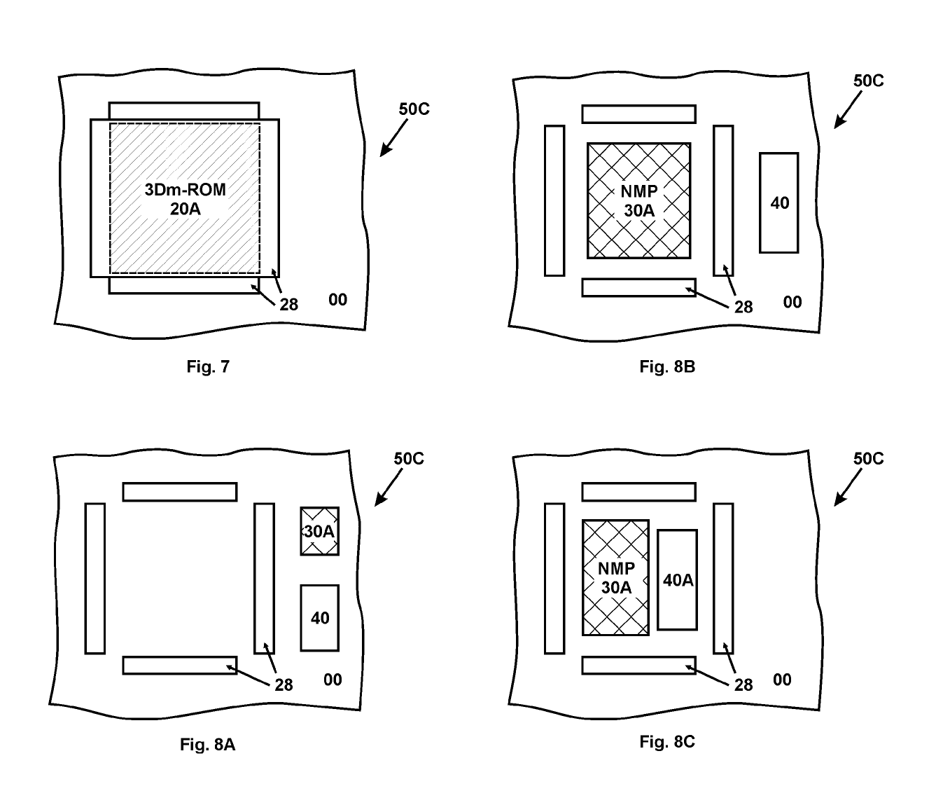

FIG. 7 is a top view of the preferred 3Dm-ROM_{S} chip 50C, showing the 3Dm-ROM array 20A (shaded areas) and its associated peripheral circuit 28. FIGS. 8A-8C illustrate three cases of the 3Dm-ROM_{S} chip with 3Dm-ROM array 20A not shown, revealing the substrate 00. In FIG. 8A, the NMP 30 and the encryption logic 40 are formed on the substrate 00 but outside the 3Dm-ROM array 20A. In FIG. 8B, the NMP 30A is formed underneath the 3Dm-ROM array 20A. The encryption logic 40 is formed outside the 3Dm-ROM array 20A and can be shared by various 3Dm-ROM arrays. In FIG. 8C, both the NMP 30A and the encryption logic 40A are formed underneath the 3Dm-ROM array 20A. Forming at least a portion of the NMP 30A underneath the 3Dm-ROM array 20A (as in FIGS. 8B-8C) is advantageous because uncovering the underlying NMP 30A requires removal of the 3Dm-ROM array 20A, which defies the whole purpose of pirating. Note that FIGS. 7-8C and FIGS. 10AA-10BB are merely representative and are not intended to indicate any actual layout. Layout is a design choice and many configurations are possible.

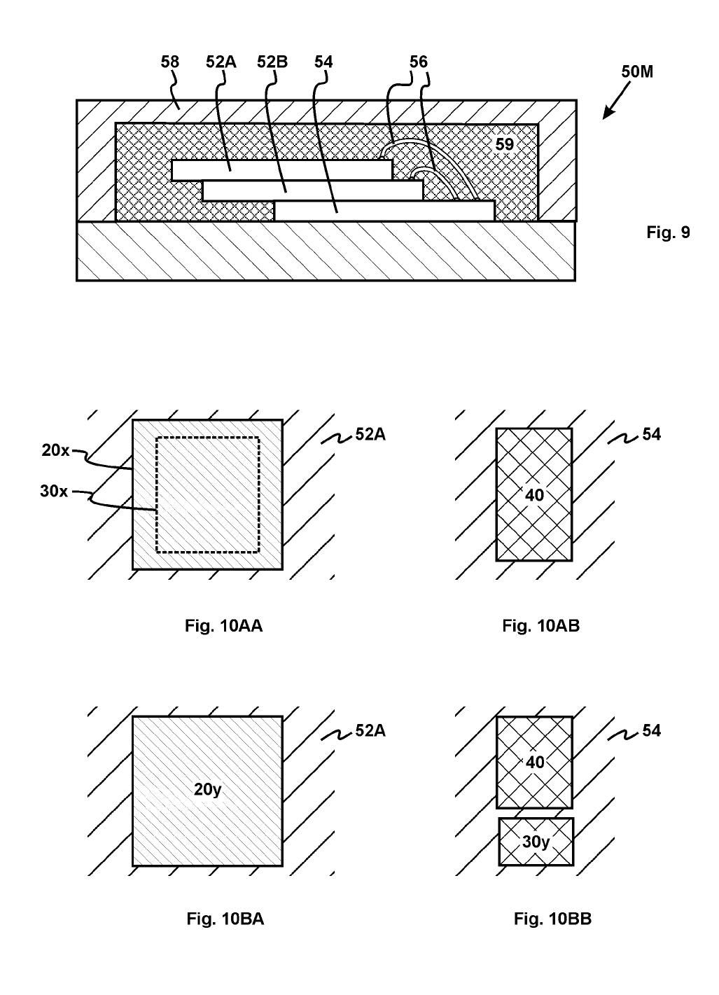

FIG. 9 is a cross-sectional view of a preferred 3Dm-ROM_{S} package 50M. In this preferred embodiment, the 3Dm-ROM 20, the NMP 30 and the encryption logic 40 are integrated into a single protective package 50M. It comprises at least one 3Dm-ROM chip 52A, 52B . . . and a support chip 54. Each 3Dm-ROM chip (e.g. 52A) comprises a plurality of mask-ROM levels. The support chip 54 can be a controller chip. All these chips (52A, 52B . . . , 54) are preferably stacked above one another and coupled to each other through bonding wires 56, then placed in a secure housing 58 filled with protective materials 59 such as molding compound. Because the intermediate signals between the 3Dm-ROM 20 and the encryption logic 40 are not exposed to the external world and would be difficult to be tampered with, this preferred embodiment provides strong copyright protection.

FIGS. 10AA-10BB illustrate two cases of the 3Dm-ROM_{S} package 50M of FIG. 9. In the case of FIGS. 10AA-10AB, the 3Dm-ROM chip 52A comprises at least one 3Dm-ROM array 20x (shaded area) and at least one NMP array 30x. The NMP array 30x is located underneath the 3Dm-ROM array 20x (FIG. 10AA). In the meantime, the support chip 54 comprises the encryption logic 40 (FIG. 10AB). In the case of FIGS. 10BA-10BB, the 3Dm-ROM chip 52A comprises at least one 3Dm-ROM array 20y (FIG. 10BA), while the support chip 54 comprises at least one NMP array 30y and the encryption logic 40 (FIG. 10BB).

Although both hard-code the content data into their physical structures, 3Dm-ROM_{S} provides stronger copyright protection than optical storage (e.g. DVD, BD). This is because 3Dm-ROM_{S} is a semiconductor storage and can be easily integrated with another semiconductor circuit component (e.g. the NMP and the encryption logic), whereas the optical storage cannot. Overall, besides high storage density and low cost, 3Dm-ROM_{S} provides excellent copyright protection.

While illustrative embodiments have been shown and described, it would be apparent to those skilled in the art that may more modifications than that have been mentioned above are possible without departing from the inventive concepts set forth therein. For example, the 3D-ROM cells disclosed in the specification use diodes. In fact, they can use transistors and other elements. Moreover, the inventive concepts can be easily extended to other types of mask-ROM. The invention, therefore, is not to be limited except in the spirit of the appended claims.

What is claimed is:

1. A secure three-dimensional mask-programmed read-only memory (3Dm-ROM_{S}), comprising:
at least a three-dimensional mask-programmed read-only memory (3Dm-ROM) for storing mass information, said mass information being printed by a mask-programming means;
a non-mask-programmed memory (NMP) for storing at least a key, said key being written by a non-mask-programming means; and
an encryption logic for encrypting selected data from said mass information with said key;
wherein said selected data is encrypted with different keys for first and second 3Dm-ROM_{S} devices from a same 3Dm-ROM_{S} batch;
whereby compromising said first 3Dm-ROM_{S} device would not compromise said second 3Dm-ROM_{S} device.

2. The 3Dm-ROM_{S} according to claim 1, wherein said non-mask-programming means is an optical programming means.

3. The 3Dm-ROM_{S} according to claim 2, wherein said NMP is a laser-programmable read-only memory (LP-ROM).

4. The 3Dm-ROM_{S} according to claim 1, wherein said non-mask-programming means is an electrical programming means.

5. The 3Dm-ROM_{S} according to claim 4, wherein said NMP is an electrically-writable read-only memory.

6. The 3Dm-ROM_{S} according to claim 1, wherein said non-mask-programming means is a magnetic programming means.

7. The 3Dm-ROM_{S} according to claim 1, wherein said NMP stores a plurality of keys and said 3Dm-ROM_{S} further comprises a key-selection logic for selecting at least a key from said NMP.

8. The 3Dm-ROM_{S} according to claim 7, wherein said key-selection logic selects said key based on file, whereby two different files stored in said 3Dm-ROM_{S} are encrypted with different keys.

9. The 3Dm-ROM_{S} according to claim 7, wherein said key-selection logic selects said key based on time, whereby said selected data is encrypted with different keys at different time.

10. The 3Dm-ROM_{S} according to claim 1, wherein said 3Dm-ROM, said NMP and said encrypting means are integrated into a single chip.

11. The 3Dm-ROM_{S} according to claim 1, wherein said 3Dm-ROM, said NMP and said encrypting means are integrated into a single protective package.

12. A secure mask-programmed read-only memory (mask-ROM) chip, comprising:
a semiconductor substrate containing transistors;
a mask-ROM array formed on said substrate for storing mass information, said mass information being printed by a mask-programming means;
a non-mask-programmed memory (NMP) formed in said substrate for storing at least a key, said key being written by a non-mask-programming means; and
an encryption logic formed in said substrate for encrypting selected data from said mass information with said key;
wherein said selected data are encrypted with different keys for first and second secure mask-ROM chips in a same secure mask-ROM batch;
whereby compromising said first secure mask-ROM chip would not compromise said second secure mask-ROM chip.

13. The secure mask-ROM chip according to claim 12, wherein said mask-ROM array is a three-dimensional mask-ROM (3Dm-ROM) array comprising a plurality of monolithically stacked mask-ROM levels.

14. The secure mask-ROM chip according to claim 13, wherein said NMP and said encrypting logic are formed below said 3Dm-ROM array.

15. The secure mask-ROM chip according to claim 14, wherein said NMP and/or said encrypting logic is formed underneath said 3Dm-ROM array.

16. The secure mask-ROM chip according to claim 12, wherein said NMP stores a plurality of keys and said secure mask-ROM chip further comprises a key-selection logic for selecting at least a key from said NMP.

17. The secure mask-ROM chip according to claim 12, wherein said non-mask-programming means is an optical programming means.

18. The secure mask-ROM chip according to claim 12, wherein said NMP is a laser-programmable read-only memory (LP-ROM).

19. The secure mask-ROM chip according to claim 12, wherein said non-mask-programming means is an electrical programming means.

20. The secure mask-ROM chip according to claim 12, wherein said non-mask-programming means is a magnetic programming means.
